(19) United States
(12) Patent Application Publication
(10) Pub. No.: US 2011/0149126 A1
(43) Pub. Date: Jun. 23, 2011

(54) MULTIBAND IMAGE PICKUP METHOD AND DEVICE

(75) Inventors: Masanori Mitsui, Tokyo (JP); Takeyuki Ajito, Tokyo (JP); Yasuhiro Komiya, Tokyo (JP); Akira Matsushita, Tokyo (JP)

(73) Assignee: OLYMPUS CORPORATION, Tokyo (JP)

(21) Appl. No.: 12/645,121

(22) Filed: Dec. 22, 2009

(51) Int. Cl. H04N 5/335

(52) U.S. Cl. 348/278; 348/E05.091

(57) ABSTRACT

The invention provides a multiband image pickup method and device with good color reproducibility, which is capable of imaging a subject with a number of imaging bands of not less than 4 colors and obtain a color image of not less than 3 colors without lowering spatial resolution. A first imaging of a subject image is performed by a single-plate imaging device having a color filter composed of 5 colors of R, O, G, C and B. A control unit shifts the imaging element by a shift drive unit so that each light having formed an image on the each filter of R, B and G of the color filters forms an image on a position of the each filter of O, C and G of the color filters and, thereafter a second imaging is performed. A image processing unit generates 2 3-band Bayer images based on captured images obtained by the first imaging and the second imaging, and generates a multiband image of not less than 3 colors from them.

### CROSS-REFERENCE TO RELATED APPLICATION

The present application claims priority from Japanese Application No. 2008-166410, filed on Jun. 25, 2008, the content of which is incorporated herein by reference.

### BACKGROUND OF THE INVENTION

1. Field of the Invention

This invention relates to a single-plate imaging device for imaging a subject with a number of imaging bands of not less than 4 colors.

2. Description of the Related Art

Conventionally, filters of 3 primary colors are used in an imaging device. However, since color reproducibility is not necessarily good with the filters of 3 primary colors, it has been attempted to enhance the color reproducibility by increasing the number of color filters to realize multiband imaging.

As a known method for realizing multiband imaging, for example, Japanese Patent Application Laid-open Publication No. 2006-314043 describes a method including steps of switching a plurality of color filters provided in an optical path of an imaging optics, capturing images, each corresponding to each color in order, and synthesizing each image to obtain a color image. Another example is Japanese Patent Application Laid-open Publication No. 2004-172832 which describes a method including steps of separating an incident light from a subject with a half mirror or a dichroic mirror and obtaining spectral images of 3 colors with different wavelengths from each separated incident light to obtain images of a total of 6 colors. Japanese Patent Application Laid-open Publication No. 2005-286649 also describes a method including a step of imaging by using an imaging element having filters of not less than 4 colors in a single-plate imaging device.

Particularly, the single-plate imaging device using filters of not less than 4 colors is advantageous in that downsizing is possible and imaging time can also be shortened, since a filter switching mechanism and/or division of the optical path are unnecessary.

For example, in the imaging device disclosed in Japanese Patent Application Laid-open Publication No. 2005-286649, the light from a subject is collected by a lens 101, received on an imaging element 103 through regularly arrayed color filters of 6 colors, and converted into analog signals as shown in FIG. 16. Thereafter, these analog signals are converted into digital signals in an A/D conversion unit 105 through a gain adjusting unit 104. Furthermore, signals of 1 color per pixel obtained in the imaging element 103 are converted into digital signals of 6 colors per pixel by interpolating in a multiband color interpolation processing unit 106 and output as image signals of 6 colors from an image output interface 108 through an exposure, color adjusting and image output format conversion unit 107. In addition, the exposure, color adjusting and image output format conversion unit 107 determines gain of each color signal of the gain adjusting unit 4, and also determines exposure time based on the signal level distribution of each color signal so as to obtain image signals with the proper degree of exposure.

However, in the multiband image pickup device using color filters as described above, since a filter of 1 color corresponds to each pixel of the imaging element, signals of the other colors for the pixel cannot be obtained. Therefore, as the above example, the other color signals of the pixel are derived from surrounding pixel signals by interpolating. As a result, there is a problem that to realize multiband imaging in more wavelengths incurs lower spatial resolution of each band image, more occurrences of false color and the like.

### SUMMARY OF THE INVENTION

It is, therefore, an object of the invention made in view of the above point to provide a multiband image pickup method and device superior in color reproducibility, which is capable of imaging a subject with a number of imaging bands of not less than 4 colors and obtaining a color image of not less than 3 colors without lowering spatial resolution.

The first aspect of the invention, which achieves the object described above, is a multiband image pickup method for capturing a subject image with a single-plate imaging element having color filters of not less than 4 colors, the method comprising: an imaging step including sub-steps of performing a first imaging of the subject image, shifting the subject image by a predetermined shift amount so that each light having formed an image on a filter of a first color of the color filters forms an image on a position of the filters of a second color different from the first color of the color filters, and performing a second imaging; and a multiband image generation step of generating a multiband image of at least not less than 3 colors based on images obtained by the first imaging and the second imaging.

The second aspect of the invention resides in the multiband image pickup method according to the first aspect, wherein the imaging step comprises a plural sets of image capturing sub-step of performing a plural sets of the first imaging and the second imaging under different imaging conditions; and a selection sub-step of selecting a set of images from the plural sets of images obtained in the plural sets of image capturing sub-step, and the multiband image generation step generates a multiband image of at least not less than 3 colors based on the set of captured images selected at the selection sub-step.

The third aspect of the invention, which achieves the object described above, is a multiband image pickup device for capturing a subject image with a single-plate imaging element having color filters of not less than 4 colors through an imaging optics, the multiband image pickup device comprising: a shift unit for selectively shifting the subject image so that each light having formed an image on a filter of a first color of the color filters forms an image on a position of a filter of a second color different from the first color of the color filters; and an image processing unit for generating a multiband image of at least not less than 3 colors based on 2 images obtained by capturing with the imaging element before and after the shift of the subject image by the shift unit.

The forth aspect of the invention resides in the multiband image pickup device according to the third aspect, wherein the shift unit relatively shifts the imaging optics and the imaging element within an imaging plane.

The fifth aspect of the invention resides in the multiband image pickup device according to the third aspect, wherein the color filters are arrayed so that each light having formed an image on a filter of a third color different from the first color and the second color before the shift forms an image on a position of a filter of the same color as the third color after the shift.

The sixth aspect of the invention resides in the multiband image pickup device according to the third aspect, wherein the image processing unit comprises a multiband image synthesis unit for generating 2 images having number of bands less than the number of imaging bands based on 2 images obtained by each imaging before and after the shift and demosaicing each of the 2 images to generate a multiband image.

According to the invention, by using a single-plate imaging element having color filters of not less than 4 colors, the first imaging is performed, a subject image is shifted by a predetermined shift amount so that each light having formed an image on a filter of the first color of the color filters before the shift forms an image on a position of a filter of the second color different from the first color of the color filters after the shift, the second imaging is performed, and a multiband image of at least not less than 3 colors is generated based on images obtained by the first imaging and the second imaging, thereby it is possible to image the subject with imaging bands of not less than 4 colors and to obtain a color image of not less than 3 colors without lowering spatial resolution as compared to the case of imaging with imaging bands of 3 colors.

### BRIEF DESCRIPTION OF THE DRAWING

FIG. 1 is a block diagram showing a schematic configuration of a multiband image pickup device according to Embodiment 1 of the invention;

FIG. 2 is a diagram showing a unit array of color filters and shift of the same unit array;

FIG. 3 is a diagram illustrating displacement of an imaged position on color filters by shift of color filters;

FIG. 4 is a functional block diagram showing a schematic configuration of an image processing unit according to the Embodiment 1;

FIG. 5 is a functional block diagram showing a schematic configuration of a multiband image processing unit;

FIG. 6 is a block diagram showing a schematic configuration of a registration processing unit;

FIG. 7 is a diagram illustrating the process in a registration processing unit;

FIG. 8 is a flow chart showing an operation of a multiband image pickup device according to the Embodiment 1;

FIG. 9 is a block diagram showing a schematic configuration of a multiband image pickup device according to Embodiment 2 of the invention;

FIG. 10 is a diagram illustrating displacement of imaged positions on color filters by shift of a lens;

FIG. 11 is a block diagram showing a schematic configuration of a multiband image pickup device according to Embodiment 3 of the invention;

FIG. 12 is a functional block diagram showing a schematic configuration of an image processing unit according to the Embodiment 3;

FIG. 13 is a flow chart showing an operation of a multiband image pickup device according to the Embodiment 3;

FIG. 14 is a flow chart showing details of the multiband image pickup in the flow chart of FIG. 13;

FIG. 15 is a flow chart showing details of evaluated value calculation in the flow chart of FIG. 14; and

FIG. 16 is a diagram showing an example of a conventional multiband image pickup device.

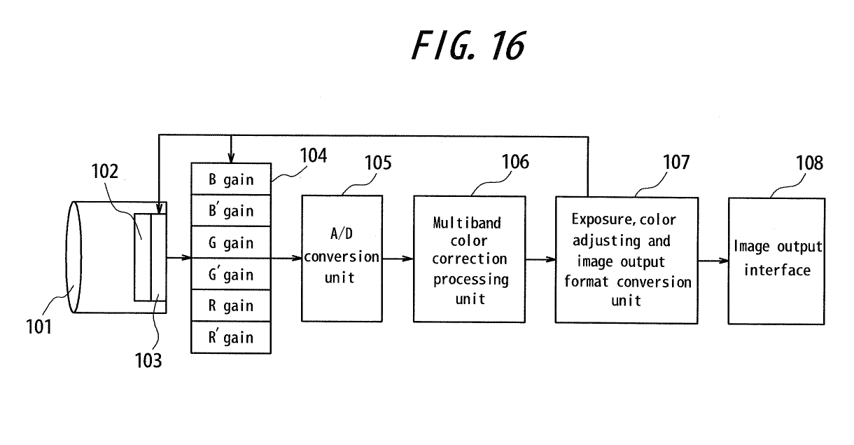

### DESCRIPTION OF THE PREFERRED EMBODIMENTS

Preferred embodiments of the present invention are described below with reference to the accompanying drawings.

### Embodiment 1

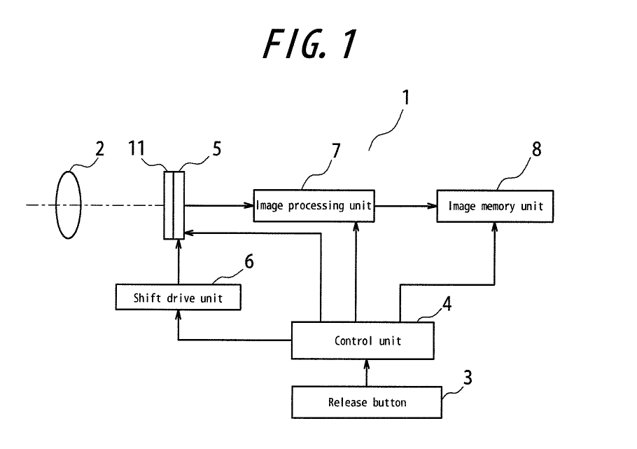

FIG. 1 is a block diagram showing a schematic configuration of a multiband image pickup device according to Embodiment 1 of the invention. The multiband image pickup device 1 uses an imaging element 5 having a color filter 11 of filters of 5 colors, and synthesizes 2 images captured by shifting the imaging element 5 to generate a multiband image.

The multiband image pickup device 1 comprises an imaging lens 2, a release button 3, the imaging element 5, a shift drive unit 6, an image processing unit 7, an image memory unit 8 and a control unit 4 for controlling the whole operation.

When the release button 3 is pushed down, the control unit 4 instructs the imaging element 5 to perform a first imaging, and when the imaging is completed, the control unit 4 immediately controls a shift amount by the shift drive unit 6 to shift the imaging element 5 and instructs the imaging element 5 to perform a second imaging. Thereby, the first imaging and the second imaging are performed in series in short time. Here, the control unit 4 and the shift drive unit 6 constitute a shift unit. Additionally a well-known mechanism such as an ultrasonic motor and a piezo element which are used for shifting the imaging element in image stabilization can be used to constitute the shift unit 6.

Next, the pixel configuration and the shift amount of the color filter 11 of the imaging element 5 will be described below.

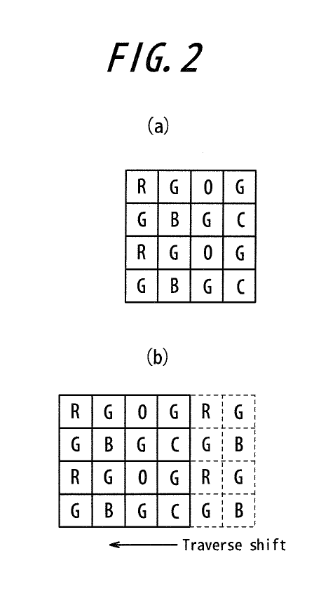

The color filter 11 is configured with filters in a unit array shown in FIG. 2 (a) being repeatedly arranged on a plane. In the diagram, a filter transmitting each color is shown as R for red, O for orange, G for green, C for cyan and B for blue (hereinafter, notations will be R for red, O for orange, G for green, C for cyan and B for blue, accordingly). As shown in FIG. 2 (a), the unit array is a 16-pixel array of 4 rows and 4 columns, the unit array being composed of color filters in the order of RGOG in the first row from the left side, GBGC in the second row, RGOG in the third row same as the first row, and GBGC in the fourth row same as the second row. Hereinafter, filters in a unit array of 4 rows and 4 columns as above are denoted as RGOG-GBGC-RGOG-GBGC. Here, R, O and G are the first color, the second color and the third color, respectively.

The control unit 4 shifts the imaging element 5 in a transverse direction (hereinafter referred to as a horizontal direction) thereof by 2 pixels by the shift drive unit 6, according to the pixel size of the filter. FIG. 2 (b) shows the state of the color filters 11 shifted integrally with the imaging element 5 from the state of (a) by 2 pixels to the left. By the shift, an O filter is located in the position of the subject image where an R filter was located before the shift and the R filter is in the position where the O filter was located. For a B filter and a C filter, similar displacement also occurs before and after the shift. On the other hand, a G filter after the shift is located in a position where the G filter was located before the shift.

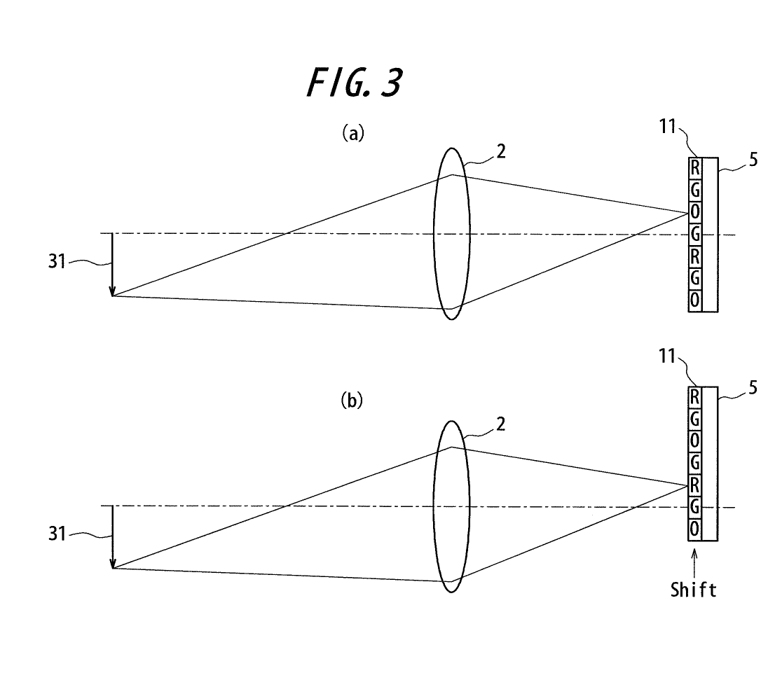

By shifting the imaging element 5 as such, a pixel position where the subject image images on the imaging element 5 displaces as shown in FIG. 3. FIG. 3 is a diagram showing an example of the shift of the imaging element 5. Here, FIG. 3 (a) shows before the shift and FIG. 3 (b) shows after the shift. In FIG. 3 (a), a leading portion of a subject 31 shown by an arrow forms an image on an O filter, and thereby image signals of only an O component transmitting through the O filter is extracted. When the imaging element 5 shifts for 2 pixels in the direction indicated by the arrow as shown in FIG. 3 (b), the leading portion of the same subject 31 forms an image on the R filter and only an R component transmitting through the R filter is detected.

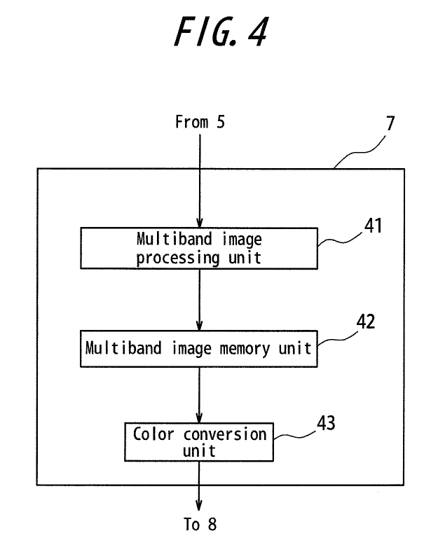

FIG. 4 is a functional block diagram showing a schematic configuration of the image processing unit 7 according to the Embodiment 1. The image processing unit 7 comprises a multiband image processing unit 41, a multiband image memory unit 42 and a color conversion unit 43. The multiband image processing unit 41 synthesizes a multiband image with 5 bands corresponding to each color of the aforementioned RGBOC based on image signals of 2 captured images from the above set of 2 imaging. The synthesized multiband image is temporarily memorized in the multiband image memory unit 42. The color conversion unit 43 converts the multiband image with 5 bands memorized in the multiband image memory unit 42 to generate a multiband image with 3 bands.

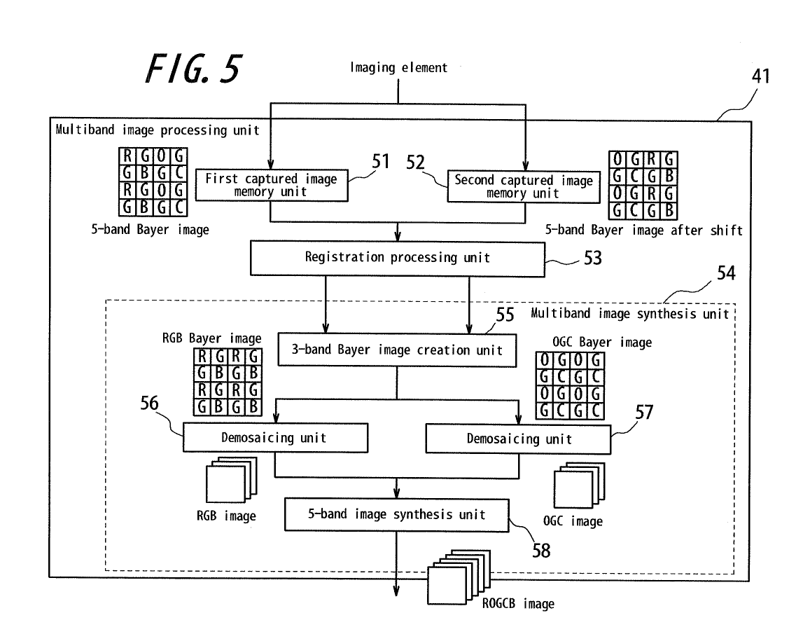

FIG. 5 is a functional block diagram showing a schematic configuration of the multiband image processing unit 41. The multiband image processing unit 41 comprises a first captured image memory unit 51 for memorizing the image from the first imaging by the imaging element 5, a second captured image memory unit 52 for memorizing the image from the second imaging, a registration processing unit 53 for registering the first captured image and the second captured image, and a multiband image synthesis unit 54 to be described.

When imaging is performed in the multiband image pickup device 1, other than misregistration of pixels by the aforementioned shift of the imaging element 5, misregistration of pixels of captured image due to hand movement and the like occurs. The registration processing unit 53 calculates the misregistration of pixel position in a horizontal direction due to them, corrects the misregistration, and processes the image of the second imaging for processing in the multiband image synthesis unit 54.

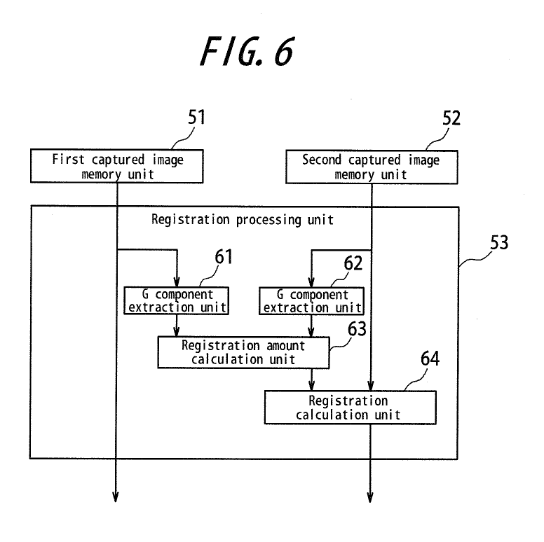

Specifically, the registration processing unit 53, as the schematic configuration shown in FIG. 6, comprises 2 G component extraction units 62 and 63, each corresponding to the first captured image and the second captured image, a registration amount calculation unit 63 for calculating registration correction amount based on the extracted G components, and a registration calculation unit 64 for calculating pixel value of desired color pixel in each pixel position of the second captured image based on the registration correction amount.

The registration amount calculation unit 63 performs each demosaicing process on the first captured image and the second captured image to generate an image of only G components from the G components extracted by the G component extraction units 61 and 62. Furthermore, while the 2 generated G images are relatively displaced in a horizontal direction, the correlation value of the images is calculated, thereby pixel misregistration of the second captured image to the first captured image in a relative position of both images where the value is the largest is determined to be a misregistration amount, the shift amount being expressed in number of pixels with a shift direction of the imaging element 5 being positive. The misregistration amount is also called registration correction amount because the registration correction can be performed by registering a pixel coordinate of the second captured image to a pixel coordinate of the first captured image according to the misregistration amount. In the misregistration amount, since the amount for 2 pixels is generated by shifting the imaging element 5, a shift amount showing an actual misregistration generated by hand movement and the like is a value after subtracting 2 pixels from the misregistration amount.

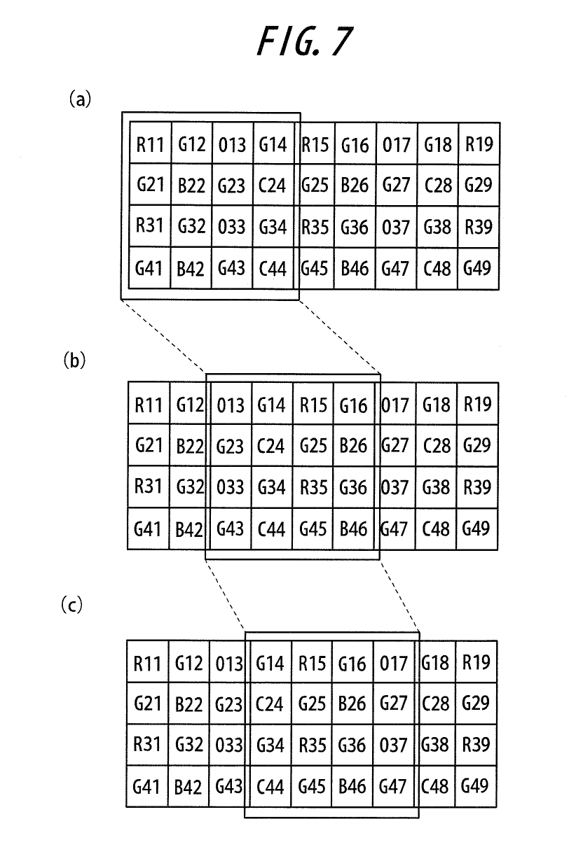

The calculation process of the registration correction amount (misregistration amount) will be more specifically described with reference to FIG. 7. FIG. 7 shows a portion of the color filter 11 of the imaging element 5, where R, O, C and B denote filter colors of each pixel, and 2 numerals added on the right side of each R, O, G, C and B denote a coordinate of the pixel filter on the color filter 11.

FIG. 7 (a) shows the first imaging and FIG. 7 (b) shows the second imaging without hand movement, namely when the shift amount is 0. In this case, as compared to the first captured image, by the shift of the imaging element 5 for 2 pixels to the left by the shift drive unit 6, the subject image of the second captured image is captured as being shifted to the right for 2 pixels. With attention to the G component, each G element of G12, G14, G21, G23, G32, G34, G41 and G42 in FIG. 7 (a) corresponds to G pixels of G14, G16, G23, G25, G34, G36, G43 and G45 in FIG. 7 (b) shifted for 2 pixels in a horizontal direction, Therefore, in demosaiced images of both images, correlation also becomes the highest in the position shifted for 2 pixels.

As above, it is possible to detect a particular pixel position of the first captured image as corresponding to a position 2 pixels right to the same pixel position of the second captured image by using the G pixel component, and the subject image captured in a unit array with R11 and C44 as vertexes on a diagonal in FIG. 7 (a) corresponds to the subject image captured in a unit array with O13 and B46 as vertexes on a diagonal in FIG. 7 (b). Namely, to the unit array of RGOG-GBGC-RGOG-GBGC of the first captured image, in the second captured image, image signals in a unit array of OGRG-GCGB-OGRG-GCGB is obtained for the same subject image. As described hereinbelow, the multiband image synthesis unit 54 uses the pixel array to synthesize a multiband image.

On the other hand, FIG. 7 (c) shows an example of misregistration of 3 pixels in total occurred with misregistration of 1 pixel further occurred by hand movement and the like in addition to the shift of the imaging element 5 to the left. Similar to the case of FIG. 7 (b), by using the G pixel component, it is possible to calculate that the misregistration amount of FIG. 7 (c) is 3 pixels, i.e., the shift amount by hand movement and the like is 1 pixel. Therefore, in this case, relative to the first captured image, the second captured image is misregistered to the right for 3 pixels on the color filters 11.

However, in this example, relative to the unit array of RGOG-GBGC-RGOG-GBGC of the first captured image, an array of GRGO-CGBG-GRGO-CGBG with G14 and G17 as vertexes on a diagonal corresponds to the same subject image of the second image. Since this array is incompatible to a process by the multiband image synthesis unit 54 to be described, a pixel value of each pixel is calculated assuming the case that a pixel array of OGRG-GCGB-OGRG-GCGB is in a position of a pixel array of 4 rows and 4 columns including G14 and G47 by interpolation and the like in the registration calculation unit 64 in FIG. 6.

For example, a pixel value in the assuming case that the O filter is in a position of G14 in FIG. 7 (c) can be calculated by interpolation based on pixel values of surrounding O pixels such as O13 and O17, and a distance between each O pixel and G14. Also, a pixel value in the assuming case that the G filter is in a position of R15 can be similarly calculated by interpolation using pixel values of surrounding G pixels such as G14 and G16. By interpolating similarly below, the registration calculation unit 64 can calculate a pixel value of each pixel in OGRG-GCGB-OGRG-GCGB of the second captured image as a unit array corresponding to an image in RGOG-GBGC-RGOG-GBGC of the first captured image as a unit array.

When the shift amount is a multiple of 4, since it is possible to obtain an image in OGRG-GCGB-OGRG-GCGB as a unit array by simply shifting a pixel coordinate according to the misregistration amount, the interpolation process in the registration calculation unit 64 described above becomes unnecessary. Although the misregistration amount is 3 pixels in the above example, even when the misregistration amount is not an integral multiple of the pixel size, it is possible to calculate the pixel value by interpolation in the registration calculation unit 64 as described above.

As above, the registration processing unit 53 outputs image signals of the first captured image in RGOG-GBGC-RGOG-GBGC as a unit array, and registers the second captured image to the first captured image, based on pixel values of each color of captured images from the first captured image memory unit 51 and the second captured image memory unit 52 as input, and further processes image signals of the second captured image to output image signals in OGRG-GCGB-OGRG-GCGB as a unit array corresponding to the pixel position of the above first captured image.

Next, the configuration of the multiband image synthesis unit 54 shown in FIG. 5 will be described. The multiband image synthesis unit 54 comprises a 3-band Bayer image creation unit 55, demosaicing units 56 and 57, and a 5-band image synthesis unit 58. The 3-band Bayer image creation unit 55 synthesizes the first captured image in RGOG-GBGC-RGOG-GBGC as a unit array transmitted from the registration processing unit 53 and the second captured image in GRGO-OGBG-GRGO-CGBG as a unit array to generate two images in 3-band Bayer arrays of RGB and OGC. Therefore, the 3-band Bayer image creation unit 55 partially interchanges each O pixel and C pixel of the first captured image with each R pixel and B pixel of the second captured image locating in the same positions, respectively.

The demosaicing units 56 and 57 demosaic images in each Bayer array generated in the 3-band Bayer image creation unit 55 to generate each image of ROB and each image of OGC. The 5-band image synthesis unit 58 creates each image of 5 bands of ROGCB from each image of ROB and each image of OGC generated in the demosaicing units 56 and 57.

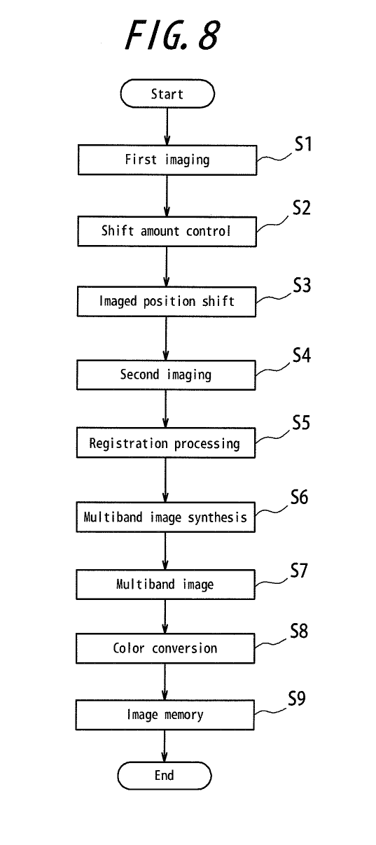

Next, the imaging operation of the subject using the multiband image pickup device 1 according to the present embodiment will be described with reference to the flow chart shown in FIG. 8.

First, when the release button 3 is pressed down by a user, the control unit 4 performs the first imaging by the imaging element 5 (step S1). Then, the control unit 4 controls the shift amount by the shift drive unit 6 (step S2), shifts the imaging element 5 in a horizontal direction for 2 pixels (step S3), and performs the second imaging by the imaging element 5 again (step S4). The first imaging and the second imaging are performed in series in a short time.

The first captured image and the second captured image are each provided to the image processing unit 7, each temporarily stored in the first captured image memory unit 51 and the second captured image memory unit 52, and registered in the multiband image processing unit 41 within the image processing unit 7 shown in FIG. 5 (step S5). By the registration process, the second captured image is, for a corresponding position of the first captured image in RGOG-GBGC-RGOG-GBGC as a unit array, output as an image in GRGO-CGBG-GRGO-CGBG as a unit array as described above. From these 2 captured images, an ROB Bayer image and an OGC Bayer image are generated in the multiband image synthesis unit 54 in FIG. 5, the Bayer images undergo a demosaicing process in the demosaicing units 56 and 57 so as to generates two 3-band images from each image of ROB and each image of OGC, and thereby a multiband image with 5 bands of ROGCB from these two 3-band images is generated (step S6).

The multiband image with 5 bands generated in the multiband image synthesis unit 54 is temporarily saved in the multiband image memory unit 42 in FIG. 4 (step 7). Thereafter, the multiband image with 5 bands is color-converted into a color image with 3 primary colors of R, G and B, for example, by the color conversion unit 43 (step S8). The control unit 4 provides the color image created thereby to the image memory unit 8 in FIG. 1 and stores it in a memory medium not shown (step S9). The control unit 4 confirms completion of all the process and exits the process.

As described above, according to the embodiment, since the imaging element 5 having the color filter 11 of 5 colors of ROGCB in a predetermined unit array is used, 2 images are captured before and after the shift of the imaging element 5 by the shift drive unit 6, and two 3-band images of RGB and OGC are generated from the 2 captured images, it is possible to suppress the occurrence of false color due to lowered spatial resolution and generate a 5-band image of superior color reproducibility from the two 3-band images, as compared to a conventional imaging with 3 bands. Also, by using the 5-band image, it is possible to generate an image with 3 bands of RGB of superior'color reproducibility.

Moreover, since 8 pixels, that is half of the unit array of the color filter 11 arrayed in 4 rows and 4 columns, are set to be G pixels, and G components are used to register before and after the shift of the imaging element 5, even when there is hand movement or a movement of the subject between the first captured image and the second captured image, it is possible to correct the displacement of the subject image on the imaging element due to this and suppress the occurrence of false color.

Furthermore, since the color filter 11 includes G components with high brightness in the same array and at the same ratio as the case of a conventional 3-band Bayer array, i.e. at a ratio of a half of the all pixels, it is possible to perform a conventional process using G components such as blur correction similar to a conventional way.

### Embodiment 2

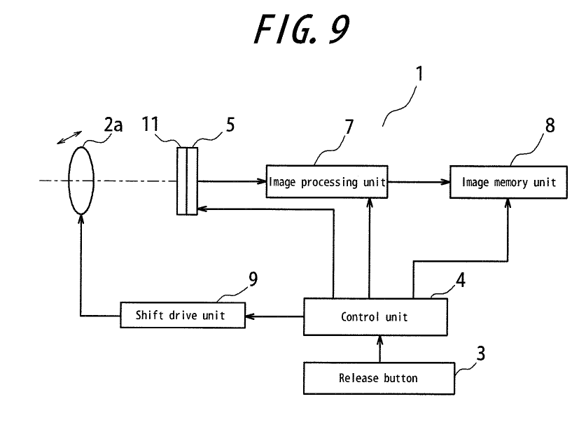

FIG. 9 is a block diagram showing a schematic configuration of a multiband image pickup device according to Embodiment 2 of the invention. In this embodiment, an imaging lens 2a as an optical element is shifted instead of shifting the imaging element 5 in the multiband image pickup device 1 according to the embodiment 1, so as to displace a pixel position where a subject image. Therefore, in the multiband image pickup device shown in FIG. 1, the shift drive unit 6 is not provided, the imaging lens 2 is replaced with the imaging lens 2a having a shift mechanism built-in for displacing the lens position in a horizontal direction, and a shift control unit 9 for controlling the shift of the lens by the shift mechanism is further provided, the shift control unit 9 being controlled by the control unit 4 to shift the imaged position of the subject on the imaging element 5 for 2 pixels. In addition, as the shift mechanism of the imaging lens 2a, for example a well-known mechanism such as an ultra sonic motor for use in image stabilization as a drive means of lens can be used.

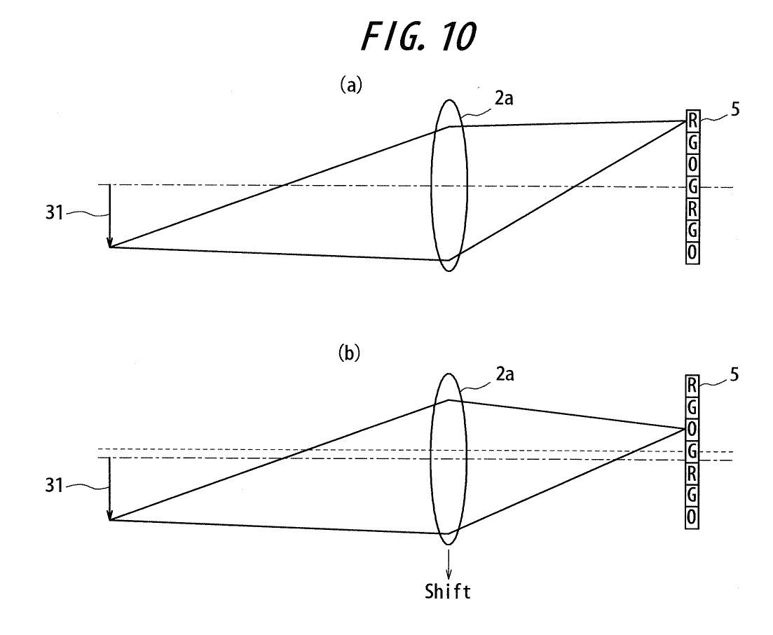

By shifting the imaging lens 2a as such, a pixel position where the subject 31 form an image on the imaging element displaces as shown in FIG. 10. FIG. 10 is a diagram showing an example of the shift of the imaging lens 2a. Here, FIG. 10 (a) shows before the shift and FIG. 10 (b) shows after the shift. In FIG. 10 (a), a leading portion of the subject 31 shown by an arrow forms an image on the R filter and thereby only the pixel value of the R component transmitting through the R filter is extracted. When the imaging lens 2a shifts downward in FIG. 10, as shown in FIG. 10 (b), since a leading portion of the same subject forms an image on the O filter, only a pixel value of the O component transmitting through the O filter is detected.

Other configurations and functions are the same as the embodiment 1. Thereby, it is possible to capture a multiband image with 5 bands similar to the embodiment 1, and also to generate an image with 3 bands of RGB of superior color reproducibility by using the 5-band image.

As described above, according to the present embodiment, since the subject image formed on the imaging element 5 is shifted by shifting the imaging lens 2a, it is possible to obtain the same effect as the embodiment 1 by using a well-known mechanism for image stabilization as a shift mechanism within the lens.

### Embodiment 3

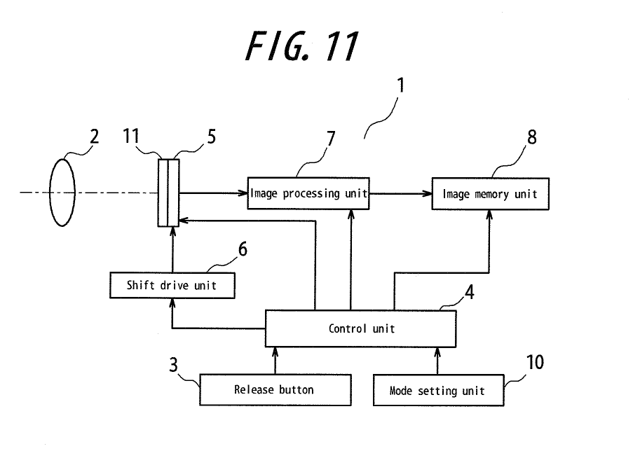

FIG. 11 is a block diagram showing a schematic configuration of a multiband image pickup device according to Embodiment 3 of the invention. This embodiment regards the first imaging and the second imaging described in the embodiment 1 as a set, performs a plurality of sets of imaging at varying shutter speed, evaluates images of a plurality of sets of captured images taken thereby, selects a set of captured images determined as the most suitable according to predetermined conditions, generates a multiband image and outputs the generated multiband image.

Therefore, in the subject embodiment, a mode setting unit 10 is further provided in the embodiment 1 shown in FIG. 1. In the mode setting unit 10, each mode of “blur prevention priority”, “S/N priority”, “AUTO” and “none” can be selected by operation of a user. When a mode is set in the mode setting unit 10, the set mode is detected in the control unit 4. Thereafter, when the release button is pushed down by the user, the control unit 4 operates the imaging element 5 and the shift drive unit 6 according to the set mode.

In the imaging of a multiband image, each mode is used for the following applications.

(1) Blur Prevention Priority:

When a subject being likely to be blurred is imaged, in addition to the imaging at an appropriate shutter speed calculated based on image signals obtained from the imaging element 5, 2 sets of imaging are performed at increased shutter speeds and a captured image with the least blurs is selected from a total of 3 sets of captured images.

(2) S/N Priority:

In addition to the imaging at the above appropriate shutter speed, 2 sets of imaging are performed at decreased shutter speeds and an captured image with the best S/N (Signal to Noise) ratio is selected from a total of 3 sets of captured images.

(3) AUTO:

Without specifying the above blur prevention priory or S/N priority, an image with comprehensively good image quality is selected from a total of 3 sets of multiband images captured at the above appropriate shutter steed, the increased shutter speed and the decreased shutter speed thereof.

(4) None:

Similar to the embodiment 1, only a set of imaging is performed at the above appropriate shutter speed.

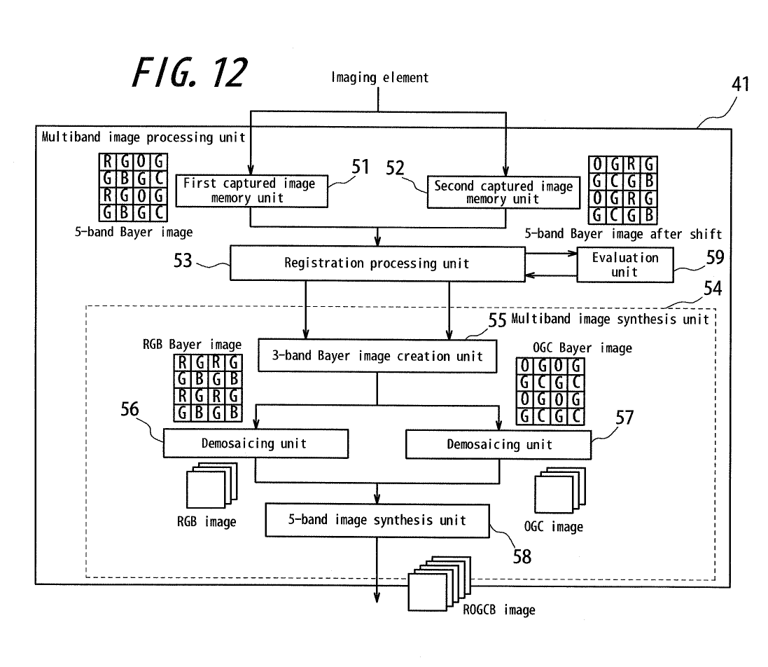

FIG. 12 is a block diagram showing a schematic configuration of the multiband image processing unit 41 in this embodiment. As shown in FIG. 12, in the embodiment, an evaluation unit 59 for evaluating the above-mentioned plurality of sets of captured images is provided in the configuration of the multiband image processing unit 41 in the embodiment 1. The evaluation unit 59 is connected to the registration processing unit 53 and adapted to receive the data of the first captured image, the second captured image, misregistration amount and the like from the registration processing unit 53, performs evaluation to be described, identify a set of captured images with the best evaluation result, and returns the identification result to the registration processing unit 53.

Since other configurations of the embodiment are the same as those of the Embodiment 1, the description is omitted.

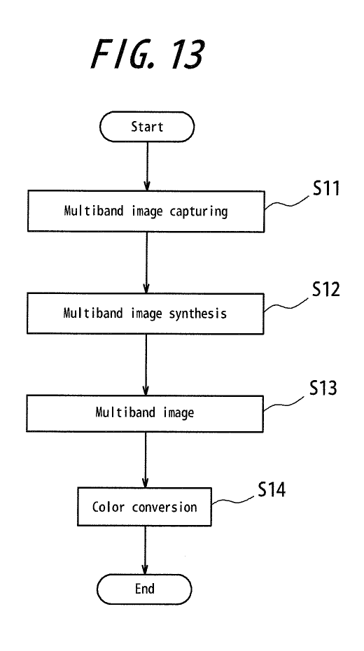

Next, the imaging operation of the multiband image pickup device 1 according to the subject embodiment will be described with reference to flow charts shown in FIGS. 13 to 15.

FIG. 13 is a flow chart showing imaging operation by the multiband image pickup device in the embodiment. In the present embodiment, first, multiband image capturing is performed according to a set mode to obtain 2 images captured before and after the shift (step S11). Thereafter, the 2 obtained images are used to synthesize a multiband image with 5 bands (step S12) similar to the Embodiment 1, and the multiband image with 5 bands is temporarily saved (step S13) then color-converted into a color image of 3 primary colors of R, G and B, for example, in the conversion unit 43 (step S14).

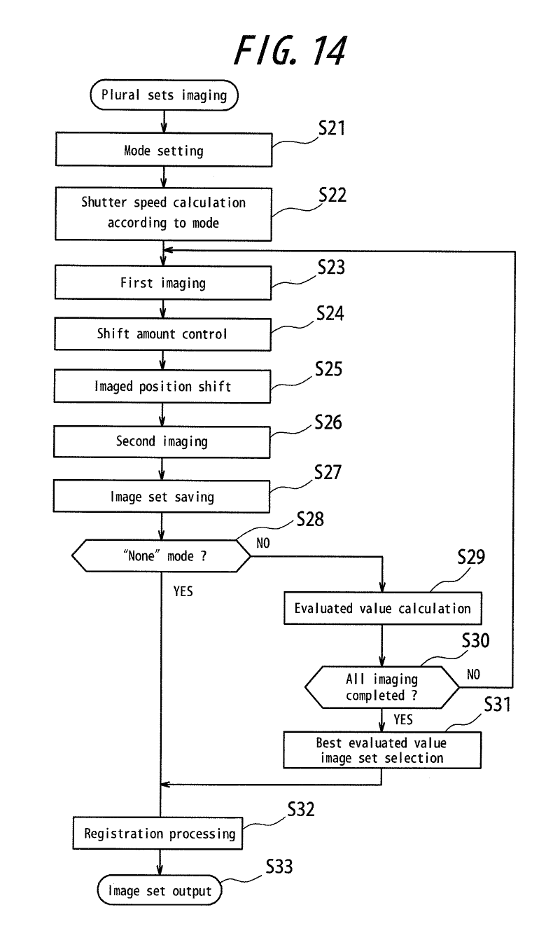

The process of obtaining an image at the step S11 will be described in more details below with reference to a flow chart shown in FIG. 14. First, before imaging, the control unit 4 identifies the imaging mode set through the mode setting unit 10 in FIG. 11 (step S21).

Next, when it is detected that the release button 3 is pushed down, the control unit 4 calculates an appropriate shutter speed based on image signals obtained from the imaging element 5. Moreover, when the mode is “blur prevention priority”, 2 different shutter speeds higher than the appropriate shutter speed are calculated. When the mode is “S/N priority”, 2 different shutter speeds lower than the appropriate shutter speed are calculated. When the mode is “AUTO”, one shutter speed for each of higher and lower than the appropriate shutter speed is calculated. Thereby, in each mode of “blur prevention priority”, “S/N priority” and “AUTO”, 3 shutter speeds are respectively calculated (step S22). Additionally, when the mode is “none”, only the appropriate shutter speed is calculated.

Thereafter, the control unit 4 starts imaging. First, the control unit 4 performs the first imaging at the appropriate shutter speed (step S23). Next, the control unit 4, similarly to the embodiment 1, controls the shift amount by the shift drive unit 6 (step S24), shifts the imaging element 5 in a horizontal direction for 2 pixels (step S25) and performs the second imaging (step S26). The images from the first and the second imaging are provided to each image processing unit 7 and temporarily stored in the first captured image memory unit 51 and the second captured image, memory unit 52, respectively (step S27).

Next, when the set mode is “none”, the control unit 4, similar to the embodiment 1, register the first and the second captured images (step S32) and outputs it to the multiband image synthesis unit 34 in FIG. 12 (step S33).

On the other hand, when the mode is “blur prevention priority”, “S/N priority” or “AUTO”, a set of captured images are evaluated and the evaluation result is calculated as an evaluated value (step S29). Next, the control unit 4 sets the other 2 shutter speeds calculated at the step S22 in order, and repeatedly performs each step of the steps S23, S24, S25, S26, S27 and S29. When each set of 2 imaging is completed and calculation for image evaluated value is finished (step S30), the evaluation unit 59 compares 3 image evaluated values corresponding to the 3 shutter speeds to select a set of images with the highest evaluated value (step S31).

Thereafter, the evaluation unit 59 provides information on the set of images selected above to the registration processing unit 53, and the registration processing unit 53 performs a registration process on the set of images similarly to the embodiment 1 (step S32) and outputs the images from the first and the second imaging to the multiband image synthesis unit 54 (step S33).

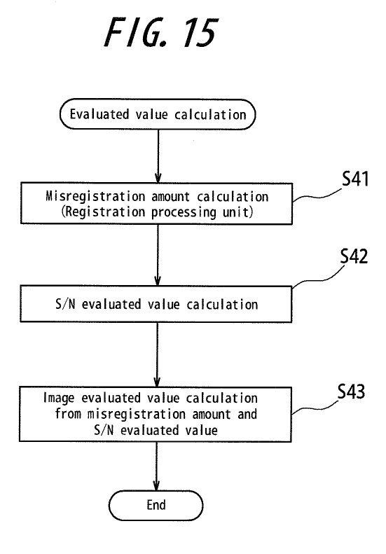

Next, calculation of the evaluated value for the set of captured images in the step S29 will be described with reference to the flow chart shown in FIG. 15. The registration processing unit 53 in FIG. 12 calculates the misregistration amount from each captured image memorized in the first captured image memory unit 51 and the second captured image memory unit 52 by the same method as described in the embodiment 1 (step S41).

The registration processing unit 53 provides the calculated misregistration amount and the images from the first and second imaging to the evaluation unit 59. In the evaluation unit 59, for example, ISO sensitivity, distributed value of signals calculated for the selected area having a small change in pixel value of G pixel, a number of saturated pixels, S/N evaluated value defined by a number of underexposed pixels and the like are calculated (step S 42).

Thereafter, in the evaluation unit 59, an image evaluated value is calculated from the misregistration amount calculated at the step S41 and the S/N evaluated value calculated at the step S42 by using a predetermined evaluation formula (step S43). Here, the evaluation formula can seta coefficient to put weight on the misregistration amount to calculate when the mode is “blur prevention priority” and put weight on the S/N evaluated amount to calculate when the mode is “S/N priority”. When the calculation of the image evaluated value is finished, the evaluation unit 59 saves the image evaluated value and notifies the completion of the image evaluated value calculation to the control unit 4.

As described above, according to the present embodiment, since the imaging of a plurality of sets of multiband images is performed at a shutter speed according to the imaging mode, the plurality of sets of captured images are evaluated to select the best set of images, it is possible to take a multiband image suitable for every imaging scene and condition in addition to the effects in the embodiment 1.

It should be noted that the invention is not limited to the above embodiments but various changes and modifications can be made. For example, although the color filters 11 of the imaging element 5 are composed of filters of 5 colors, it is not limited to this but possible to array filters of 4 colors or not less than 6 colors.

In the flow chart shown in the embodiment 1 in FIG. 8, after the multiband image synthesis at the step S6, the generated multiband image with 5 bands may be saved directly in the image memory unit 8 without performing the multiband image save at the step S7 and the color conversion at the step S8.

Although the misregistration amount is calculated for the entire captured images in the registration processing unit 53, an area of prioritizing the misregistration correction may be determined. For example, background, foreground, designated subject, a subject automatically recognized or the like can be prioritized. When the subject automatically recognized is prioritized, the registration processing unit 53 is made to have a function for subject recognition or face recognition and prioritize the correction of area of the recognized subject, for example, by putting weight on the area of the recognized subject when calculating correlation of 2 G images.

Although the image evaluated value is calculated from the misregistration amount of the images of the first and the second imaging and the S/N value in the embodiment 3, correlation of the images from the first imaging and the image from the second imaging after the registration may be used instead of the misregistration amount. If the correlation is low, it can be determined that the difference between the first captured image and the second captured image after the registration are large, so the image quality is bad.

What is claimed is:

1. A multiband image pickup method for capturing a subject image with a single-plate imaging element having color filters of not less than 4 colors, the method comprising:
an imaging step including sub-steps of performing a first imaging of the subject image, shifting the subject image by a predetermined shift amount so that each light having formed an image on a filter of a first color of the color filters forms an image on a position of the filters of a second color different from the first color of the color filters, and performing a second imaging; and
a multiband image generation step of generating a multiband image of at least not less than 3 colors based on images obtained by the first imaging and the second imaging.

2. The multiband image pickup method according to claim 1, wherein the imaging step comprises a plural sets of image capturing sub-step of performing a plural sets of the first imaging and the second imaging under different imaging conditions; and a selection sub-step of selecting a set of images from the plural sets of images obtained in the plural sets of image capturing sub-step, and the multiband image generation step generates a multiband image of at least not less than 3 colors based on the set of captured images selected at the selection sub-step.

3. A multiband image pickup device for capturing a subject image with a single-plate imaging element having color filters of not less than 4 colors through an imaging optics, the multiband image pickup device comprising:
a shift unit for selectively shifting the subject image so that each light having formed an image on a filter of a first color of the color filters forms an image on a position of a filter of a second color different from the first color of the color filters; and
an image processing unit for generating a multiband image of at least not less than 3 colors based on 2 images obtained by capturing with the imaging element before and after the shift of the subject image by the shift unit.

4. The multiband image pickup device according to claim 3, wherein the shift unit relatively shifts the imaging optics and the imaging element within an imaging plane.

5. The multiband image pickup device according to claim 3, wherein the color filters are arrayed so that each light having formed an image on a filter of a third color different from the first color and the second color before the shift forms an image on a position of a filter of the same color as the third color after the shift.

6. The multiband image pickup device according to claim 3, wherein the image processing unit comprises a multiband image synthesis unit for generating 2 images having number of bands less than the number of imaging bands based on 2 images obtained by each imaging before and after the shift and demosaicing each of the 2 images to generate a multiband image.
